(19) United States
(12) Patent Application Publication
(10) Pub. No.: US 2026/0177997 A1
(43) Pub. Date: Jun. 25, 2026

(54) METHOD FOR GENERATING PROCESS PARAMETERS

(71) Applicant: Industrial Technology Research Institute, Hsinchu (TW)

(72) Inventors: Ming-Cheng Tsai, New Taipei City (TW); Hsuan-Yu Huang, Taipei City (TW); Ning-Yuan Lyu, Miaoli County (TW); Da-Jeng Yao, Taipei City (TW); Chih-Ming Ho, Los Angeles, CA (US); Chia-Hung Wu, New Taipei City (TW)

(73) Assignee: Industrial Technology Research Institute, Hsinchu (TW)

(21) Appl. No.: 19/422,384

(22) Filed: Dec. 16, 2025

Related U.S. Application Data
(60) Provisional application No. 63/735,905, filed on Dec. 19, 2024.

(30) Foreign Application Priority Data
Nov. 14, 2025 (TW) 114144516

(51) Int. Cl. G05B 13/04

(52) U.S. Cl. CPC G05B 13/042

(57) ABSTRACT

A method for generating process parameters includes the following steps. Process parameters and upper limits and lower limits corresponding to the process parameters are established. Multiple sets of test parameters corresponding to the process parameters are established using an experimental planning method. Multiple optimization targets corresponding to the sets of test parameters are established using an experimental simulation method or using an experiment based on process design and the sets of test parameters. A set of optimized process parameters and an optimization target corresponding to the set of optimized process parameters are calculated using an optimization algorithm with the sets of test parameters as training parameters.

### CROSS-REFERENCE TO RELATED APPLICATION

This application claims the priority benefits of U.S. provisional application Ser. No. 63/735,905, filed on Dec. 19, 2024, and Taiwan application serial no. 114144516, filed on Nov. 14, 2025. The entirety of each of the above-mentioned patent applications is hereby incorporated by reference herein and made a part of this specification.

### TECHNICAL FIELD

The disclosure relates to a method for generating process parameters.

### BACKGROUND

Currently, large-scale production in factories requires tests before production to search for optimal process parameters. For example, if a test with 4 factors and 3 levels is planned, it represents 81(3⁴) sets of process parameters. That is to say, 81 samples need to be tested before production, and the optimal set of process parameters has to be searched for among the samples after the tests. Therefore, a large amount of time in the production cycle is spent searching for optimal process parameters. Moreover, the process parameters of the planned test is unable to guarantee finding process parameters that meet requirements, making large-scale production in factories often time-consuming, labor-intensive, and difficult to reduce production costs.

### SUMMARY

The disclosure provides a method for generating process parameters, which may effectively establish optimized process parameters that meet requirements.

An embodiment of the disclosure provides a method for generating process parameters, which includes the following steps. Process parameters and upper limits and lower limits corresponding to the process parameters are established. Multiple sets of test parameters corresponding to the process parameters are established using an experimental planning method. Multiple optimization targets corresponding to the sets of test parameters are established using an experimental simulation method or using an experiment based on process design and the sets of test parameters. A set of optimized process parameters and an optimization target corresponding to the set of optimized process parameters are calculated using an optimization algorithm with the sets of test parameters as training parameters.

Several exemplary embodiments accompanied with figures are described in detail below to further describe the disclosure in details.

### BRIEF DESCRIPTION OF THE DRAWINGS

The accompanying drawings are included to provide a further understanding, and are incorporated in and constitute a part of this specification. The drawings illustrate exemplary embodiments and, together with the description, serve to explain the principles of the disclosure.

FIG. 1 is a flow chart of a method for generating process parameters according to an embodiment of the disclosure.

FIG. 2 is an example of a vibration curve generated during a stamping process using the method for generating process parameters according to an embodiment of the disclosure.

FIG. 3 is a detailed flow chart of step S400 in FIG. 1.

### DETAILED DESCRIPTION OF DISCLOSURED EMBODIMENTS

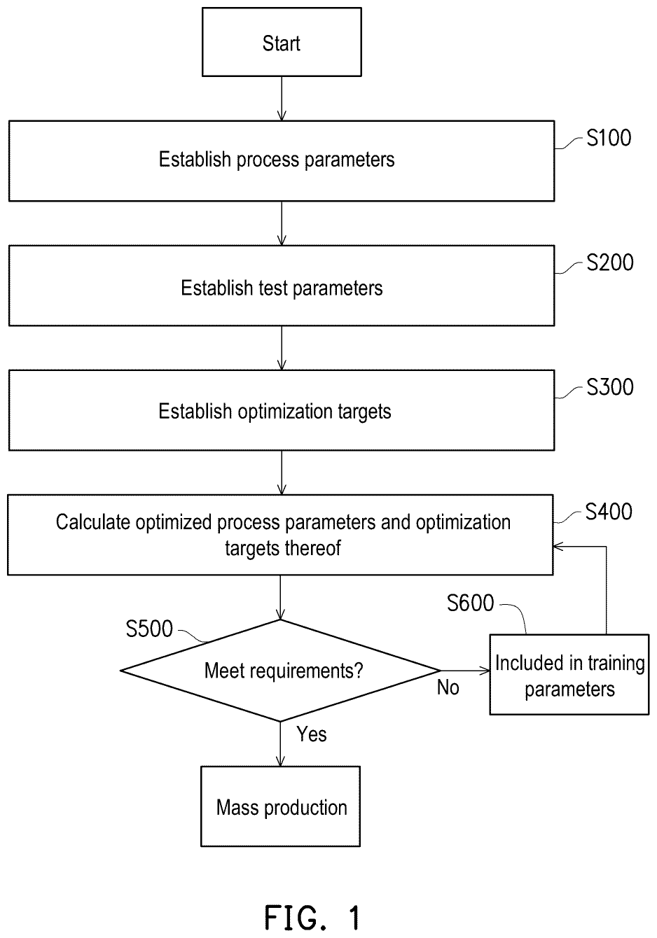

FIG. 1 is a flow chart of a method for generating process parameters according to an embodiment of the disclosure. Referring to FIG. 1, an embodiment of the disclosure provides a method for generating process parameters, which includes step S100: establish process parameters, step S200: establish test parameters, step S300: establish optimization targets, and step S400: calculate optimized process parameters and optimization targets thereof.

In detail, in the embodiment, in step S100, process parameters and upper limits and lower limits corresponding to the process parameters are established. In step S200, multiple sets of test parameters corresponding to the process parameters are established using an experimental planning method. In step S300, multiple optimization targets corresponding to the sets of test parameters are established using an experimental simulation method or using an experiment based on process design and the sets of test parameters. In step S400, a set of optimized process parameters and an optimization target corresponding to the set of optimized process parameters are calculated using an optimization algorithm with the sets of test parameters as training parameters.

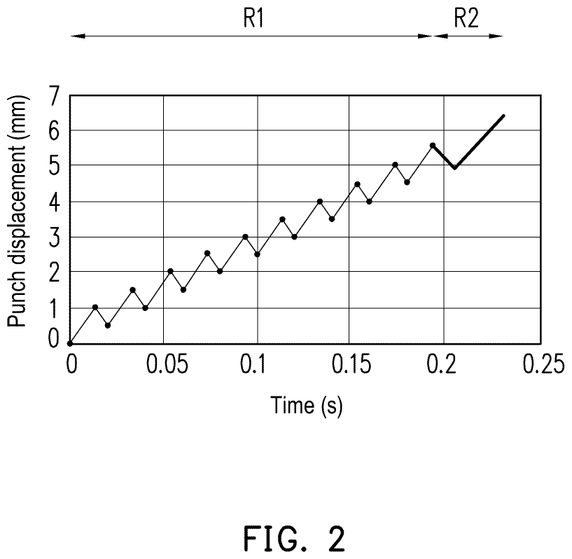

FIG. 2 is an example of a vibration curve generated during a stamping process using the method for generating process parameters according to an embodiment of the disclosure. In FIG. 2, the X axis represents time, and the Y axis represents a punch displacement. Any point on the vibration curve in FIG. 2 illustrates the stroke moved by the punch and a corresponding time point thereof. That is to say, the vibration curve illustrates the process/path of the machine tool during production and forming.

TABLE 1

| Number of times | Press-in velocity | Lifting velocity | Thinning rate |
|---|---|---|---|
| 1 | 5 | 5 | 0.3% |
| 2 | 5 | 7 | 0.6% |
| 3 | 5 | 9 | 1.0% |
| 4 | 7 | 5 | 1.1% |
| 5 | 7 | 7 | 2.0% |
| 6 | 7 | 9 | 3.1% |
| 7 | 9 | 5 | 4.0% |
| 8 | 9 | 7 | 5.9% |
| 9 | 9 | 9 | 5.9% |

Table 1 illustrates a test for manufacturing round cups using stamping process with aluminum alloy as a sample. In step S100, the process parameters may include press-in velocity and lifting velocity, and the upper limits and lower limits of the press-in velocity and lifting velocity are determined by conditions such as machine tool limits, sample materials (for example, conditions that do not cause cracking or scratching), and the like. In step S200, the nine sets of press-in velocity and lifting velocity from number of times 1 to number of times 9 in Table 1 are nine sets of test parameters established using an experimental planning method. Therefore, in step S300, the thinning rate in Table 1 is the optimization target established using an experimental simulation method or using an experiment based on process design (i.e., corresponding to the vibration curve of FIG. 2) and the aforementioned nine sets of test parameters, i.e., corresponding to range R1 in the vibration curve of FIG. 2.

In an embodiment, the aforementioned experimental planning method may be Orthogonal Array Composite Design (OACD) or Taguchi Method, but the disclosure is not limited thereto.

In an embodiment, the aforementioned experimental simulation method adopts a numerical solving method of Finite Element Analysis (FEA) to simulate the forming behavior of materials. The FEA may be implemented through commercial software, such as (but not limited to) Dynaform or Ansys.

In an embodiment, the aforementioned process design includes at least one of forming curve, lubricant usage, demolding, and stamping force.

TABLE 2

| Number of times | Press-in velocity | Lifting velocity | Thinning rate |
|---|---|---|---|
| 1 | 5 | 5 | 0.3% |
| 2 | 5 | 7 | 0.6% |
| 3 | 5 | 9 | 1.0% |
| 4 | 7 | 5 | 1.1% |
| 5 | 7 | 7 | 2.0% |
| 6 | 7 | 9 | 3.1% |
| 7 | 9 | 5 | 4.0% |
| 8 | 9 | 7 | 5.9% |
| 9 | 9 | 9 | 5.9% |
| 10 | 5.5 | 4.8 | 7.9% |

Table 2 illustrates a set of optimized process parameters generated using an optimization algorithm. In Table 2, number of times 1 to number of times 9 are the same as Table 1, and will not be described again here. In step S400, number of times 10 in Table 2 is a set of optimized process parameters calculated using an optimization algorithm with the aforementioned nine sets of test parameters as training parameters and the optimization target/thinning rate corresponding to the set of optimized process parameters, i.e., corresponding to range R2 in the vibration curve of FIG. 2.

In an embodiment, the aforementioned optimization algorithm is Complex Systems Response (CSR), but the disclosure is not limited thereto.

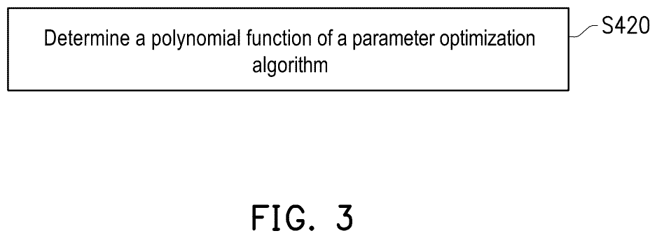

FIG. 3 is a detailed flow chart of step S400 in FIG. 1. Referring to FIG. 3, in the embodiment, the aforementioned optimization algorithm is established by one of a variety of different polynomial functions. The aforementioned step S400 includes the following step. In step S420, which polynomial function being used to establish the optimization algorithm is determined based on the number of process parameters and the minimum number of experiments.

TABLE 3

| | | Minimum number |
|---|---|---|
| Form | Function | of experiments |
| 1 | $E ( {c}_{i} , {u}_{x} , t ) = {x}_{0} ( {u}_{x} , t ) + {\sum }_{i = 1}^{P} {x}_{i} ( {u}_{x} , t ) {c}_{i} ( t ) + {\sum }_{i = 1}^{P} {x}_{ii} ( {u}_{x} , t ) {c}_{i}^{2} ( t ) + {\sum }_{1 \leq i < j \leq p} {x}_{ij} ( {u}_{x} , t ) {c}_{i} ( t ) {c}_{j} ( t )$ | (P² + 3P + 2)/2 |
| 2 | $E ( {c}_{i} , {u}_{x} , t ) = {x}_{0} + {\sum }_{i = 1}^{P} {x}_{i} ( {u}_{x} , t ) {c}_{i} ( t ) + {\sum }_{i = 1}^{P} {x}_{ii} ( {u}_{x} , t ) {c}_{i}^{2} ( t )$ | 2P + 1 |
| 3 | $E ( {c}_{i} , {u}_{x} , t ) = {x}_{0} + {\sum }_{i = 1}^{P} {x}_{i} ( {u}_{x} , t ) {c}_{i} ( t ) + {\sum }_{1 \leq i < j \leq p} {x}_{ij} ( {u}_{x} , t ) {c}_{i} ( t ) {c}_{j} ( t )$ | (P² + P + 2)/2 |
| 4 | $E ( {c}_{i} , {u}_{x} , t ) = {x}_{0} + {\sum }_{i = 1}^{P} {x}_{ii} ( {u}_{x} , t ) {c}_{i}^{2} ( t ) + {\sum }_{1 \leq i < j \leq p} {x}_{ij} ( {u}_{x} , t ) {c}_{i} ( t ) {c}_{j} ( t )$ | (P² + P + 2)/2 |
| 5 | $E ( {c}_{i} , {u}_{x} , t ) = {x}_{0} + {\sum }_{i = 1}^{P} {x}_{i} ( {u}_{x} , t ) {c}_{i} ( t )$ | P + 1 |

Table 3 illustrates a variety of different polynomial functions. In each of the polynomial functions, cᵢ(t) is the i-th process parameter, E(cᵢ,uₓ,t) is the optimization target, xᵢ(uₓ,t) is the response of the first-order coefficient (which represents process characteristics, such as but not limited to, thinning rate, minimum forming force, stress, strain, etc.) to cᵢ(t), cᵢ²(t) is the second-order term of cᵢ(t), xᵢⱼ(uₓ,t) is the response of the second-order coefficient (which represents process characteristics, such as but not limited to, thinning rate, minimum forming force, stress, strain, etc.) to cᵢ²(t), xᵢⱼ(uₓ,t) is the interaction coefficient (which represents the thinning rate response to the interaction between cᵢ(t) and cⱼ(t)).

Taking the polynomial function of form 1 as an example. The aforementioned Table 1 illustrates two process parameters, therefore the number of process parameters P=2. By analogy, if the optimization algorithm is established by the polynomial function of form 1, then the minimum number of experiments is (P²+3P+2)/2=9, therefore at least nine sets of test parameters need to be established in Table 1 or Table 2.

Referring to FIG. 1 again, in the embodiment, the method for generating process parameters further includes step S500: compare multiple optimization targets corresponding to multiple sets of test parameters, compare the optimization target corresponding to the set of optimized process parameters, and compare a known optimal optimization target; confirm whether the difference between the optimization target of the set of optimized process parameters and the known optimal optimization target is less than a threshold.

In the embodiment, the method for generating process parameters further includes step S600: if the difference between the optimization target of the set of optimized process parameters and the known optimal optimization target is greater than the threshold, recalculate a set of optimized process parameters and an optimization target corresponding to the recalculated set of optimized process parameters using the optimization algorithm with the sets of test parameters and the set of optimized process parameters as training parameters; confirm whether the difference between the optimization target corresponding to the recalculated set of optimized process parameters and the known optimal optimization target is less than the threshold.

For example, the thinning rate of the set of optimized process parameters at number of times 10 in Table 2 is 7.9%, and the known optimal thinning rate is 8.1%. If the thinning rate of the set of optimized process parameters meets the requirements, the process may proceed to the production stage. Conversely, if the thinning rate of the set of optimized process parameters does not meet the requirements, as shown in step S600, the nine sets of test parameters in Table 2 and the optimized process parameters at number of times 10 are used as training parameters, and a set of optimized process parameters is recalculated using the optimization algorithm. By analogy, the vibration curve of FIG. 2 in range R2 advances the feed rate once more.

In addition, in the embodiment, when the experimental simulation method is used or the experiment is used to establish the optimization targets corresponding to the sets of test parameters in step S300, the experimental simulation method or the experiment sequentially tests the sets of test parameters on a sample to establish the optimization targets.

For example, the nine sets of test parameters shown in the aforementioned Table 1 and Table 2, the corresponding thinning rates thereof are obtained by sequentially (and cumulatively) testing a sample from the test parameters of number of times 1 to the test parameters of number of times 9, as shown in range R1 of FIG. 2.

In summary, in an embodiment of the disclosure, the method for generating process parameters includes the following steps. Process parameters and upper limits and lower limits corresponding to the process parameters are established. Multiple sets of test parameters corresponding to the process parameters are established using an experimental planning method. Multiple optimization targets corresponding to the sets of test parameters are established using an experimental simulation method or using an experiment based on process design and the sets of test parameters. A set of optimized process parameters and an optimization target corresponding to the set of optimized process parameters are calculated using an optimization algorithm with the sets of test parameters as training parameters. Compared to the tests before production in large-scale production of conventional factories, the method for generating process parameters of the embodiment of the disclosure uses computational procedures such as an experimental planning method, an experimental simulation method, and an optimization algorithm to replace the procedure of testing samples. Therefore, the method for generating process parameters may effectively and time-savingly establish optimized process parameters.

Moreover, in an embodiment of the disclosure, the method for generating process parameters sequentially tests multiple sets of test parameters on a sample and establishes multiple optimization targets.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method for generating process parameters, comprising:
establishing the process parameters and upper limits and lower limits corresponding to the process parameters;
establishing a plurality of sets of test parameters corresponding to the process parameters using an experimental planning method;
establishing a plurality of optimization targets corresponding to the plurality of sets of test parameters using an experimental simulation method or using an experiment based on process design and the plurality of sets of test parameters; and
calculating a set of optimized process parameters and an optimization target corresponding to the set of optimized process parameters using an optimization algorithm with the plurality of sets of test parameters as training parameters.

2. The method for generating process parameters according to claim 1, wherein the experimental planning method is orthogonal array composite design or Taguchi method.

3. The method for generating process parameters according to claim 1, wherein the experimental simulation method is finite element analysis.

4. The method for generating process parameters according to claim 1, wherein the process design comprises at least one of forming curve, lubricant usage, demolding, and stamping force.

5. The method for generating process parameters according to claim 1, wherein the optimization algorithm is complex system response.

6. The method for generating process parameters according to claim 5, wherein the optimization algorithm is established by one of a plurality of different polynomial functions, and calculating the set of optimized process parameters and the optimization target corresponding to the set of optimized process parameters using the optimization algorithm comprises:
determining which polynomial function the optimization algorithm is established by based on a number of the process parameters and a minimum number of experiments.

7. The method for generating process parameters according to claim 1, further comprising:
comparing the plurality of optimization targets corresponding to the plurality of sets of test parameters, compare the optimization target corresponding to the set of optimized process parameters, and compare a known optimal optimization target; and
confirming whether a difference between the optimization target of the set of optimized process parameters and the known optimal optimization target is less than a threshold.

8. The method for generating process parameters according to claim 7, further comprising:
if the difference between the optimization target of the set of optimized process parameters and the known optimal optimization target is greater than the threshold, recalculating a set of optimized process parameters and an optimization target corresponding to the set of optimized process parameters after recalculation using the optimization algorithm with the plurality of sets of test parameters and the set of optimized process parameters as training parameters; and
confirming whether a difference between the optimization target corresponding to the set of optimized process parameters after the recalculation and the known optimal optimization target is less than the threshold.

9. The method for generating process parameters according to claim 1, wherein when the experimental simulation method is used or the experiment is used to establish the plurality of optimization targets corresponding to the plurality of sets of test parameters, the experimental simulation method or the experiment sequentially tests the plurality of sets of test parameters on a sample to establish the plurality of optimization targets.
